(19) United States
(12) Patent Application Publication
(10) Pub. No.: US 2020/0407278 A1
(43) Pub. Date: Dec. 31, 2020

(54) CERAMIC MEMBRANE AND METHOD FOR MANUFACTURING CERAMIC MEMBRANE BY RECYCLING MUNICIPAL SOLID WASTE INCINERATOR FLY ASH

(71) Applicant: Tamkang University, New Taipei City (TW)

(72) Inventors: Sue-Huai Gau, New Taipei City (TW); Chang-Jung Sun, Taichung City (TW); Ming-Guo Li, New Taipei City (TW); Cheng-Gang Chen, Taipei City (TW); Ching-Chieh Yang, New Taipei City (TW); Shau-Jiun Wu, Taipei City (TW)

(21) Appl. No.: 16/905,212

(22) Filed: Jun. 18, 2020

(30) Foreign Application Priority Data
Jun. 25, 2019 (TW) 108122128

(51) Int. Cl. C04B 33/13; C04B 33/135; C04B 33/04; C04B 33/20; C04B 33/30; C04B 33/32

(52) U.S. Cl. CPC C04B 33/1315; C04B 33/1355; C04B 33/04; C04B 33/20; C04B 2235/349; C04B 33/32; C04B 2235/3427; C04B 2235/36; C04B 33/30

(57) ABSTRACT

A ceramic membrane is provided, which may include glass, incinerator fly ash, kaolin and palygorskite. The weight percent of the glass may be 30˜60 wt %. The weight percent of the incinerator fly ash may be 5˜30 wt %. The weight percent of the kaolin may be 0˜50 wt %. The weight percent of the palygorskite is 0˜30 wt %.

### CROSS REFERENCE TO RELATED APPLICATION

All related applications are incorporated by reference. The present application is based on, and claims priority from, Taiwan Application Serial Number 108122128, filed on Jun. 25, 2019, the disclosure of which is hereby incorporated by reference herein in its entirety.

### TECHNICAL FIELD

The technical field relates to a ceramic membrane, in particular to an environmental-friendly ceramic membrane. The technical field further relates to the method for manufacturing the ceramic membrane by recycling municipal solid waste incinerator fly ash.

### BACKGROUND

In many developed countries and developing countries, most of municipal solid waste is processed by incineration. However, incinerating wastes would generate a huge amount of municipal solid waste incinerator fly ash (hereinafter “incinerator fly ash”) and incinerator bottom ash. The incinerator fly ash should be processed by cement-based solidification technique. According to the 2018 statistics data of Environmental Protection Administration of Taiwan, the yearly amount of solidified incinerator fly ash is up to about 300,000 tons. Thus, the disposal of such amount of the incinerator fly ash needs a large number of landfills, so the service life of the landfills is also decreased accordingly. For many countries, it is difficult to build more landfills. For the reason, the saturation situation of the landfills in many countries tends to be serious. Accordingly, it has become a trend in the future to more effectively recycle and reuse wastes. The incinerator fly ash includes a large quantity of reaction fly ash and boiler fly ash, where the reaction fly ash is one of the hazardous industrial wastes, which includes a lot of the heavy metals with high toxicity and is very hard to be recycled. Thus, most of the incinerator fly ash should be processed by the landfills.

Currently, many technologies have been developed for waste recycling and reusing, such as melting treatment, eco-cement, etc. However, melting treatment would result in high energy consumption and the problems in selling products. Eco-cement can be only applied to unreinforced concrete because including chloride; besides, only a small amount of incinerator fly ash can be recycled in the production process of eco-cement, or the quality of eco-cement would be influenced. For the reason, the incinerator fly ash cannot be effectively recycled and reused via these technologies.

Accordingly, it has become an important issue to provide a technology capable of effectively recycling and reusing incinerator fly ash.

### SUMMARY

An embodiment of the disclosure relates to a ceramic membrane is provided, which may include glass, municipal solid waste incinerator fly ash (hereinafter “incinerator fly ash”), kaolin and palygorskite. The weight percent of glass may be 30˜60 wt %. The weight percent of incinerator fly ash may be 5˜30 wt %. The weight percent of kaolin may be 5˜50 wt %. The weight percent of palygorskite is 5˜30 wt %.

Another embodiment of the disclosure relates to a ceramic membrane manufacturing method by recycling incinerator fly ash, which may include the following steps: providing glass, incinerator fly ash, kaolin and palygorskite, wherein the weight percent of glass is substantially 30˜60%, the weight percent of incinerator fly ash is substantially 5˜40%, the weight percent of kaolin is substantially 5˜50% and the weight percent of palygorskite is substantially 5˜30%; executing a water-extraction pre-process to process incinerator fly ash to generate water-extracted fly ash mixing and pressing glass, water-extracted fly ash, kaolin and palygorskite to obtain a green body; and performing a sintering process to process the green body to obtain a ceramic membrane.

Still another embodiment of the disclosure relates to a ceramic membrane manufacturing method by recycling incinerator fly ash, which may include the following steps: providing glass, incinerator fly ash and kaolin, wherein the weight percent of glass is substantially 30˜60%, the weight percent of incinerator fly ash is substantially 5˜40% and the weight percent of kaolin is substantially 5˜50%; executing a water-extraction pre-process to process the incinerator fly ash to generate water-extracted fly ash; mixing and pressing glass, water-extracted fly ash and kaolin to obtain a green body; and performing a sintering process to process the green body to obtain a ceramic membrane.

Still further another embodiment of the disclosure relates to a ceramic membrane manufacturing method by recycling incinerator fly ash, which may include the following steps: providing glass, incinerator fly ash and palygorskite, wherein the weight percent of glass is substantially 30˜60%, the weight percent of incinerator fly ash is substantially 5˜40% and the weight percent of palygorskite is substantially 10˜40%; executing a water-extraction pre-process to process incinerator fly ash to generate water-extracted fly ash; mixing and pressing glass, water-extracted fly ash and palygorskite to obtain a green body; and performing a sintering process to process the green body to obtain a ceramic membrane.

The ceramic membrane and the manufacturing method thereof by recycling incinerator fly ash in accordance with the present invention may include the following advantages:

(1) In one embodiment of the present invention, the ceramic membrane manufacturing method consumes a large amount of incinerator fly ash to manufacture ceramic membranes, so can effectively recycle and reuse the incinerator fly ash. Thus, the amount of the incinerator fly ash needed to be solidified by cement-based solidification technique can be reduced and the service life of landfills can be increased.

(2) In one embodiment of the present invention, the ceramic membrane manufacturing method consumes a large amount of incinerator fly ash and glass to manufacture ceramic membranes, so can effectively recycle and reuse both of incinerator fly ash and glass. Therefore, the method can further satisfy the environmental protection requirements.

(3) In one embodiment of the present invention, the ceramic membrane manufacturing method consumes a large amount of wastes, including incinerator fly ash and glass to manufacture ceramic membranes, so can significantly reduce the cost of the ceramic membranes. Thus, the product competitiveness of the ceramic membranes can be further increased to realize high commercial value.

(4) In one embodiment of the present invention, the ceramic membranes manufacturing by using incinerator fly ash can be applied to produce membrane bioreactors (MBR) for wastewater treatment and water recycling. Hence, incinerator fly ash can be effectively recycled and reused if the above products are acceptable by most consumers and attain high market share.

(5) In one embodiment of the present invention, the ceramic membrane manufacturing method integrates a multi-stage mixing process with a wet milling process to process incinerator fly ash, and execute a sintering process to sinter the grinded fly ash stabilized by the wet milling process to obtain a ceramic membrane. In this way, the method can effectively suppress the leaching of the heavy metals from the incinerator fly ash of the ceramic membrane, so the ceramic membrane can effectively stabilize heavy metals in fly ash. Therefore, the ceramic membrane can correspond with actual needs.

(6) In one embodiment of the present invention, the ceramic membranes manufactured by the method according to the present invention can achieve great performance in bending strength, soundness and filtering ability. Therefore, the ceramic membranes can further satisfy the actual needs.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The disclosure will become more fully understood from the detailed description given herein below and the accompanying drawings which are given by way of illustration only, and thus are not limitative of the disclosure and wherein:

FIG. 1 is a flow chart of a method for manufacturing ceramic membrane by recycling incinerator fly ash in accordance with a first embodiment of the present invention.

FIG. 2 is a flow chart of a method for manufacturing ceramic membrane by recycling incinerator fly ash in accordance with a second embodiment of the present invention.

FIG. 3 is a flow chart of a method for manufacturing ceramic membrane by recycling incinerator fly ash in accordance with a third embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

Please refer to Table 1, which is a composition table of a ceramic membrane in accordance with a first embodiment of the preset invention.

TABLE 1
Composition table of ceramic membrane

| | |
|---|---|
| Glass | 30~60 wt % |
| Municipal solid waste | 5~30 wt % (the weight percentage indicates |
| incinerator fly ash | the weight percentage of the original |
| | incinerator fly ash before the water- |
| | extraction pre-process) |
| Kaolin | 5~50 wt % |
| Palygorskite | 5~30 wt % |

As shown in Table 1, the ceramic membrane of this embodiment is manufactured by four kinds of materials, including glass (waste glass), municipal solid waste incinerator fly ash (hereinafter “incinerator fly ash”), kaolin and palygorskite, where the incinerator fly ash includes reaction fly ash and boiler fly ash.

More specifically, the weight percent of glass is substantially 30˜60%; the weight percent of incinerator fly ash is substantially 5˜30%; the weight percent of kaolin is substantially 5˜50%; the weight percent of palygorskite is substantially 10˜30%. Preferably, the weight percent of glass is substantially 40˜60%; the weight percent of incinerator fly ash is substantially 10˜30%; the weight percent of kaolin is substantially 10˜40%; the weight percent of palygorskite is substantially 10˜30%. More preferably, the weight percent of glass is substantially 50˜60%; the weight percent of incinerator fly ash is substantially 10˜20%; the weight percent of kaolin is substantially 10˜20%; the weight percent of palygorskite is substantially 10˜20%. For example, the composition of the ceramic membrane may be GFKP-6112, GFKP-6121, GFKP-6211, etc., where G, F, K and P stand for the glass, the water-extracted fly ash, the kaolin and the palygorskite respectively (some incinerator fly ash will be lost after the water-extraction pre-process, so the weight percentage of the water-extracted fly ash would be less than that of the original incinerator fly ash). Taking GFKP-6112 as an example, GFKP-6112 means the weight percent of glass is 60%, the weight percent of incinerator fly ash is 10%, the weight percent of kaolin is 10% and the weight percent of palygorskite is 20%.

As described above, the ceramic membrane is manufactured by four kinds of materials, including the glass, the incinerator fly ash, the kaolin and the palygorskite, and the four materials are mixed by a special ratio. In addition, the weight percent of incinerator fly ash can be up to 35%. Therefore, if the ceramic membrane can be put into mass production, the incinerator fly ash can be more effectively recycled. Similarly, the weight of glass is also very high; therefore, more waste glass can be recycled if the mass production of the ceramic membrane can be realized.

The incinerator fly ash can be processed by a water-extraction pre-process to generate water-extracted fly ash. As the water-extraction pre-process results in the loss of about 40% of the incinerator fly ash, the total amount of the incinerator fly ash needs to be greater than the aforementioned percentage.

In this embodiment, the water-extracted fly ash is mixed with a part of the palygorskite by a special ratio to obtain a mixture and then a wet milling process is implemented to grind the mixture in order to more effectively stabilize the heavy metals inside the incinerator fly ash and prevent the heavy metals leaching from the incinerator fly ash. Afterward, the mixture, the rest of the palygorskite, the glass and the kaolin are mixed and pressed to obtain a green body. Finally, the green body is sintered by a sintering process to obtain a ceramic membrane.

Table 2 shows the test result of the Toxicity Characteristic Leaching Procedure (TCLP) of the original incinerator fly ash, the water-extracted fly ash, the grinded fly ash and the ceramic membranes used in all embodiments.

TABLE 2
Toxicity Characteristic Leaching Procedure (TCLP)

| | Original | Water- | | | Reuse |
|---|---|---|---|---|---|
| | incinerator | extracted | Grinded | Ceramic | management |
| Element | fly ash | fly ash | fly ash | membrane | standards |
| Pb | 52.56 | 6.94 | 0.1 | N.D. | ≤4.0 |
| Cd | 0.01 | N.D. | N.D. | N.D. | ≤0.8 |
| Cu | 1.32 | 0.20 | 0.03 | N.D.~0.13 | ≤12.0 |
| Total Cr | 0.91 | 0.72 | 1.9 | 0.42 | ≤4.0 |

Unit: mg/L
N.D: not detected
Minimum detectable concentration:
Pb = 5 ppb;
Zn = 3 ppb;
Cu = 0.35 ppb;
Cd = 0.35 ppb;
Cr = 0.5 ppb

As shown in Table 2, the leaching amounts of Pb, Cu and total Cr of original incinerator fly ash are high. The test result shows the leaching amounts of Pb, Cu and total Cr of water-extracted fly ash are obviously decreased. The experiment is also performed for the grinded fly ash of the second embodiment (water-extracted fly ash not mixed with palygorskite is directly grinded by the wet milling process), the test result shows the leaching amounts of Pb, Cu and total Cr of grinded fly ash are less than those of water-extracted fly ash. The experiment is also performed for the grinded fly ashes of the other embodiments (water-extracted fly ash mixed with a part of palygorskite is grinded by the wet milling process), the test result shows the leaching amounts of Pb and Cu can be further reduced, but the leaching amount of total Cr has no obvious change. Seven different ceramic membranes (GFKP-6112, GFKP-6121, GFKP-6211, GFKP-6220, GFKP-4240, GFKP-3250 and GFKP-6202) are tested in the experiment and the leaching amounts of the heavy metals in these ceramic membranes are expressed by average values. The test result shows the leaching amounts of Pb, Cu and total Cr of the seven ceramic membranes are further decreased. According to Table 2, the leaching amount of Cd of original incinerator fly ash is already low; the leaching amounts of Cu of some ceramic membranes are N.D., so are shown by ranges.

As described above, the manufacturing method of this embodiment integrates the multi-stage mixing process with the wet milling process to process incinerator fly ash, and then perform the sintering process to sinter the grinded fly ash stabilized by the wet milling process. The above steps can effectively suppress the leaching of the heavy metals from the incinerator fly ash of the ceramic membrane.

Because incinerator fly ash is a hazardous waste, most countries adopt solidification treatment and then carry out the final disposal of landfill. Most countries do not have actual commercial reuse of incinerator fly ash, so there are no criteria for evaluation of heavy metals leaching on the reuse of incinerator fly ash. The embodiment cites Taiwan's TCLP standard for heavy metals leaching on the reuse of incinerator bottom ash to test, this standard is also similar to the EU standard. The test results showed that the heavy metals leaching was far lower than the requirement of standard on the reuse of bottom ash, indicating that the heavy metals are effectively stabilized in the ceramic membrane and have great potential for reuse.

As described above, the ceramic membrane of this embodiment can effectively stabilize heavy metals in fly ash that can recycle and reuse incinerator fly ash. The method of this embodiment can recycle hazardous industrial wastes to manufacture a product of high economic value, so can certainly improve the shortcomings of the prior art.

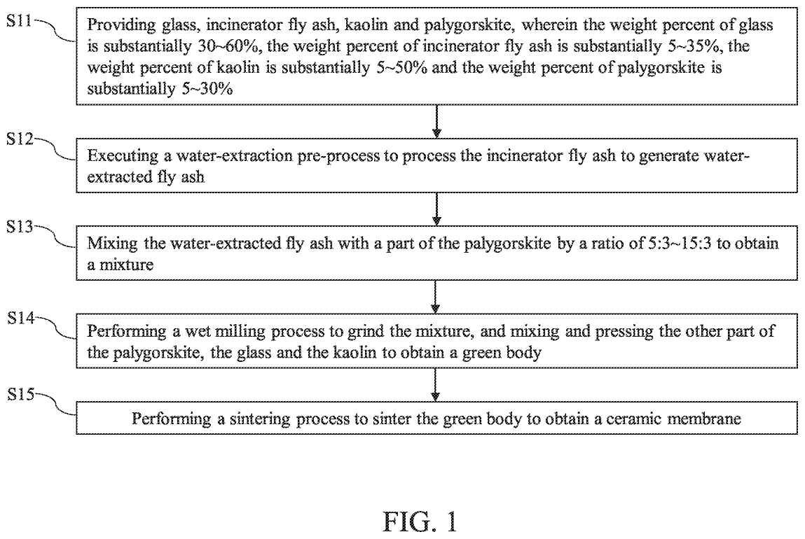

Please refer to FIG. 1, which is a flow chart of a method for manufacturing ceramic membrane by recycling incinerator fly ash in accordance with a first embodiment of the present invention. This embodiment illustrates the details of the method for manufacturing ceramic membrane by recycling incinerator fly ash.

As set forth above, the ceramic membrane of this embodiment is manufactured by four kinds of materials, including glass (waste glass), incinerator fly ash, kaolin and palygorskite, where the incinerator fly ash includes reaction fly ash and boiler fly ash. The ratio of the materials used in the method of this embodiment are as follows: the weight percent of glass is substantially 30˜60%; the weight percent of incinerator fly ash is substantially 5˜40%; the weight percent of kaolin is substantially 5˜50%; the weight percent of palygorskite is substantially 5˜30%. Preferably, the weight percent of glass is substantially 40˜60%; the weight percent of incinerator fly ash is substantially 10˜40%; the weight percent of kaolin is substantially 10˜40%; the weight percent of palygorskite is substantially 10˜30%. More preferably, the weight percent of glass is substantially 50˜60%; the weight percent of incinerator fly ash is substantially 20˜33%; the weight percent of kaolin is substantially 10˜20%; the weight percent of palygorskite is substantially 10˜20%.

In this embodiment, the above materials can be properly pre-processed before the implementation of the other processes. The glass may be waste glass; the pre-process of the glass is to remove the labels on the waste glass, clean, wash, smash the waste glass, and then crush the smashed waste glass into glass powders by a jaw crusher, and sieve the glass powders.

In this embodiment, the incinerator fly ash may be processed by a water-extraction pre-process to remove the salts unfavorable to the stabilization of the heavy metals and the durability of the sintered bodies. The pre-process of the incinerator fly ash may further include separating the water-extracted fly ash by a solid-liquid separation process to obtain a filter cake, and drying, cooling and smashing the filter cake into powders, and then sealing the powders in a container.

The kaolin may be industrial-grade kaolin. The pre-process of the kaolin is to dry the kaolin and store the dried kaolin in a sealed container.

The palygorskite may be industrial-grade palygorskite. The pre-process of the palygorskite is to process the palygorskite by a high-temperature activation process, cool, smash the palygorskite into powders, and then seal the powders in a container.

The above pre-processes are just for illustration instead of limitations, which can be modified according to actual needs.

This embodiment integrates a multi-stage mixing process with a wet milling process to effectively stabilize the heavy metals of the water-extracted fly ash. The grinding devices of this embodiment include a normal ball mill and aluminium oxide mill balls. Preferably, when the wet milling process is implemented, the water-extracted fly ash processed by the wet-extraction pre-process may be mixed with a part of the palygorskite by the ratio of 5:3˜15:3 in advance. For example, the water-extracted fly ash may be mixed with a part of the palygorskite by the ratio of 10:3 to obtain a mixture and then grind the mixture by the wet milling process.

The next step is to manufacture a green body. The mixture, the rest of the palygorskite, the glass and the kaolin are mixed with each other and pressed to obtain the green body. Preferably, the molding pressure may be 1000˜3000 psi; for instance, the molding pressure may be 2000 psi. Then, the green body may be putted into a drying oven in order to make sure the shape of the green body is complete.

The final step is to perform a sintering process. The sintering process may be implemented by a lower temperature. Preferably, the sintering temperature may be about 700° C.˜1,000° C. For example, the sintering temperature may be about 800° C., 850° C., 900° C. or 950° C.; the temperature rise rate may be 1° C.˜30° C. C/min; the holding time may be 5˜120 minutes. For instance, the sintering device may be a high-temperature rectangular furnace for atmosphere sintering.

The above manufacturing parameters are just for illustration instead of limitations, which can be modified according to actual needs.

The manufacturing method of this embodiment integrates the multi-stage mixing process with the wet milling process. More specifically, the water-extracted fly ash is mixed with a part of the palygorskite to obtain a mixture for the first time and the mixture is grinded via the wet milling process. Then, the mixture, the rest of the palygorskite, the glass and the kaolin are mixed with each other for the second time, and then the above mixture is pressed to obtain a green body. Finally, the green body is sintered via the sintering process. The above special manufacturing process can effectively suppress the leaching of the heavy metals from the incinerator fly ash of the ceramic membrane. Hence, the ceramic membrane can meet the reuse management standards and can correspond with actual needs.

Moreover, the ceramic membrane manufactured by the method according to the present invention can achieve great performance in bending strength, soundness, filtering ability, etc. Therefore, the ceramic membranes can further satisfy the actual needs.

Please refer to FIG. 1, which is a flow chart of the method for manufacturing ceramic membrane by recycling incinerator fly ash in accordance with the first embodiment of the present invention. The manufacturing process of this embodiment may include the following steps:

Step S11: providing glass, incinerator fly ash, kaolin and palygorskite, wherein the weight percent of glass is substantially 30˜60%, the weight percent of incinerator fly ash is substantially 5˜35%, the weight percent of kaolin is substantially 5˜50% and the weight percent of palygorskite is substantially 5˜30%.

Step S12: executing a water-extraction pre-process to process the incinerator fly ash to generate water-extracted fly ash.

Step S13: mixing the water-extracted fly ash with a part of the palygorskite by a ratio of 5:3˜15:3 to obtain a mixture.

Step S14: performing a wet milling process to grind the mixture, and mixing and pressing the other part of the palygorskite, the glass and the kaolin to obtain a green body.

Step S15: performing a sintering process to sinter the green body to obtain a ceramic membrane.

This embodiment further tests the ceramic membranes manufactured by the above materials and proportions in four performance standards, including heavy metal stabilization, bending strength, soundness and filtering ability. These ceramic membranes are GFKP-6112, GFKP-6121 and GFKP-6211. In the test, the temperature rise rate is 7° C./min, the sintering temperature is 900° C. and the holding time is 5 minutes. The test result shows that the TCLP (Toxicity characteristic leaching procedure) leaching concentrations of the heavy metals (Pb, Cu, Cd and total Cr) of most of the ceramic membranes can be lower than 1/10 of the reuse management standards for incinerator bottom ash of Taiwan's Environmental Protection Administration. Thus, all ceramic membranes conform to reuse management standards for incinerator bottom ash. The test result shows that the permeate fluxes of the above ceramic membranes are about 19˜100 m³/m²/d when the film pressure is about 0.17˜0.79 kgf/cm². The test result shows the filtering abilities of mixed liquid suspended solids (MLSS) of the above ceramic membranes are close to 100% (the original concentration of the suspended solids is about 2000 mg/L). The test result shows that all ceramic membranes conform to the requirement that the weight loss is less than 18% after the ceramic membranes are tested according to CNS A1167 “Method of Test for Soundness of Aggregate by Use of Sodium Sulfate or magnesium Sulfate”.

It is worthy to point out that since incinerator fly ash should be processed by cement-based solidification technique, so the disposal of incinerator fly ash needs a large number of landfill and the service life of these landfills is also decreased accordingly. Thus, the saturation situation of these landfills tends to be serious. In addition, most of currently available technologies can only be used to recycle boiler fly ash instead of incinerator fly ash, so incinerator fly ash still cannot be properly recycled. On the contrary, according to one embodiment of the present invention, the ceramic membrane manufacturing method consumes a large amount of incinerator fly ash to manufacture ceramic membranes, so can effectively recycle and reuse the incinerator fly ash. Thus, the amount of the incinerator fly ash needed to be solidified by cement-based solidification technique can be reduced and the service life of landfills can be increased.

According to one embodiment of the present invention, the ceramic membrane manufacturing method consumes a large amount of incinerator fly ash and glass to manufacture ceramic membranes, so can effectively recycle and reuse both of incinerator fly ash and glass. Therefore, the method can further satisfy the environmental protection requirements.

Besides, according to one embodiment of the present invention, the ceramic membrane manufacturing method consumes a large amount of wastes, including incinerator fly ash and glass to manufacture ceramic membranes, so can significantly reduce the cost of the ceramic membranes. Thus, the product competitiveness of the ceramic membranes can be further increased to realize high commercial value.

Further, in one embodiment of the present invention, the ceramic membranes manufacturing by using incinerator fly ash can be applied to produce membrane bioreactors (MBR) for wastewater treatment and water recycling. Hence, incinerator fly ash can be effectively recycled and reused if the above products are acceptable by most consumers and attain high market share.

Moreover, in one embodiment of the present invention, the ceramic membrane manufacturing method integrates a multi-stage mixing process with a wet milling process to process incinerator fly ash, and execute a sintering process to sinter the grinded fly ash stabilized by the wet milling process to obtain a ceramic membrane. In this way, the method can effectively suppress the leaching of the heavy metals from the incinerator fly ash of the ceramic membrane, so the ceramic membrane can effectively stabilize heavy metals in fly ash. Therefore, the ceramic membrane can correspond with actual needs.

Furthermore, in one embodiment of the present invention, the ceramic membranes manufactured by the method according to the present invention can achieve great performance in bending strength, soundness and filtering ability. Therefore, the ceramic membranes can further satisfy the actual needs.

Please refer to Table 3, which is a composition table of a ceramic membrane in accordance with a second embodiment of the preset invention.

TABLE 3
Composition table of ceramic membrane

| | |
|---|---|
| Glass | 30~60 wt % |
| Incinerator fly ash | 5~40 wt % |
| Kaolin | 10~50 wt % |

As shown in Table 3, the difference between this embodiment and the first embodiment is that the ceramic membrane of this embodiment is manufactured by three kinds of materials, including glass (waste glass), incinerator fly ash and kaolin.

The ratio of the materials used in the method of this embodiment are as follows: the weight percent of glass is substantially 30˜60%; the weight percent of incinerator fly ash is substantially 5˜40%; the weight percent of kaolin is substantially 10˜50%. Preferably, the weight percent of glass is substantially 40˜60%; the weight percent of incinerator fly ash is substantially 10˜40%; the weight percent of kaolin is substantially 20˜50%. More preferably, the weight percent of glass is substantially 30˜40%; the weight percent of incinerator fly ash is substantially 20˜33%; the weight percent of kaolin is substantially 40˜50%. As described above, since the water-extraction pre-process results in the loss of about 40% of the incinerator fly ash, the total amount of the incinerator fly ash needs to be greater than the aforementioned percentage. For instance, the ceramic membranes of this embodiment may be GFKP-6130, GFKP-6220, GFKP-4240 and GFKP-3250. Compared with the previous embodiment, the ceramic membranes of this embodiment do not include palygorskite, so the cost of the ceramic membranes of this embodiment is less than that of the ceramic membranes of the previous embodiment.

The manufacturing method of this embodiment executes a water-extraction pre-process to pre-process the incinerator fly ash to obtain water-extracted fly ash and then performs a wet-grinding process to effectively stabilize the heavy metals inside the water-extracted fly ash. Afterward, the manufacturing method of this embodiment implements a mixing process to mix the water-extracted fly ash, the glass and the kaolin and presses the mixture to obtain a green body. Finally, the manufacturing method of this embodiment executes a sintering process to sinter the green body to obtain a ceramic membrane. The above special manufacturing process can effectively suppress the leaching of the heavy metals from the incinerator fly ash of the ceramic membrane, so the ceramic membrane can meet the reuse management standards. Thus, the ceramic membrane manufactured by the manufacturing method of this embodiment can correspond with actual needs.

Similarly, the ceramic membranes manufactured by the method according to the present invention can achieve great performance in bending strength, soundness and filtering ability. Therefore, the ceramic membranes can further satisfy the actual needs.

The manufacturing parameters of this embodiment are similar to those of the previous embodiment, so will not be described therein again.

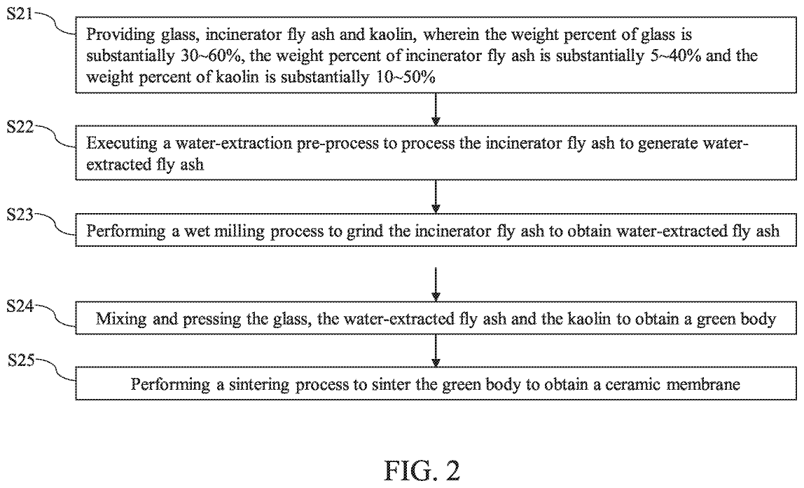

Please refer to FIG. 2, which is a flow chart of the method for manufacturing ceramic membrane by recycling incinerator fly ash in accordance with the second embodiment of the present invention. The manufacturing process of this embodiment may include the following steps:

Step S21: providing glass, incinerator fly ash and kaolin, wherein the weight percent of glass is substantially 30˜60%, the weight percent of incinerator fly ash is substantially 5˜40% and the weight percent of kaolin is substantially 10˜50%.

Step S22: executing a water-extraction pre-process to process the incinerator fly ash to generate water-extracted fly ash.

Step S23: performing a wet milling process to grind the incinerator fly ash to obtain water-extracted fly ash.

Step S24: mixing and pressing the glass, the water-extracted fly ash and the kaolin to obtain a green body.

Step S25: performing a sintering process to sinter the green body to obtain a ceramic membrane.

This embodiment further tests the ceramic membranes manufactured by the above materials and proportions in four performance standards, including heavy metal stabilization, bending strength, soundness and filtering ability. These ceramic membranes are GFKP-6220, GFKP-4240 and GFKP-3250. In the test, the temperature rise rate is 7° C./min, the sintering temperature is 1000° C. and the holding time is 60 minutes. The test result shows that the TCLP (Toxicity characteristic leaching procedure) leaching concentrations of the heavy metals (Pb, Cu, Cd and total Cr) of most of the ceramic membranes can be lower than 1/10 of the reuse management standards for incinerator bottom ash of Taiwan's Environmental Protection Administration. Thus, all ceramic membranes conform to reuse management standards for incinerator bottom ash. The test result shows that the permeate fluxes of the above ceramic membranes are about 19˜100 m³/m²/d when the film pressure is about 0.17˜0.79 kgf/cm². The test result shows the filtering abilities of mixed liquid suspended solids (MLSS) of the above ceramic membranes are close to 100% (the original concentration of the suspended solids is about 2000 mg/L). The test result shows that all ceramic membranes conform to the requirement that the weight loss is less than 18% after the ceramic membranes are tested according to CNS A1167 “Method of Test for Soundness of Aggregate by Use of Sodium Sulfate or magnesium Sulfate”.

TABLE 4
Composition table of ceramic membrane

| | |
|---|---|
| Glass | 30~60 wt % |
| Incinerator fly ash | 5~40 wt % |
| Palygorskite | 10~40 wt % |

As shown in Table 4, the difference between this embodiment and the first embodiment is that the ceramic membrane of this embodiment is manufactured by three kinds of materials, including glass (waste glass), incinerator fly ash and palygorskite.

The ratio of the materials used in the method of this embodiment are as follows: the weight percent of glass is substantially 30˜60%; the weight percent of incinerator fly ash is substantially 5˜40%; the weight percent of palygorskite is substantially 10˜40%. Preferably, the weight percent of glass is substantially 40˜60%; the weight percent of incinerator fly ash is substantially 10˜40%; the weight percent of palygorskite is substantially 10˜30%. More preferably, the weight percent of glass is substantially 50˜60%; the weight percent of incinerator fly ash is substantially 20˜33%; the weight percent of palygorskite is substantially 20˜30%. As described above, since the water-extraction pre-process results in the loss of about 40% of the incinerator fly ash, the total amount of the incinerator fly ash needs to be greater than the aforementioned percentage. For instance, the ceramic membranes of this embodiment may be GFKP-6202 and GFKP-6103.

The manufacturing method of this embodiment executes a water-extraction pre-process to pre-process the incinerator fly ash to obtain water-extracted fly ash. Similarly, the manufacturing method of this embodiment also integrates a multi-stage mixing process with a wet milling process. More specifically, the water-extracted fly ash is mixed with a part of the palygorskite to obtain a mixture for the first time and the mixture is grinded via the wet milling process. Then, the mixture, the rest of the palygorskite and the glass are mixed with each other for the second time, and then the above mixture is pressed to obtain a green body. Finally, the green body is sintered via the sintering process. The above special manufacturing process can effectively suppress the leaching of the heavy metals from the incinerator fly ash of the ceramic membrane. Hence, the ceramic membrane can meet the reuse management standards and can correspond with actual needs.

Similarly, the ceramic membranes manufactured by the method according to the present invention can achieve great performance in bending strength, soundness and filtering ability. Therefore, the ceramic membranes can further satisfy the actual needs.

The manufacturing parameters of this embodiment are similar to those of the previous embodiment, so will not be described therein again.

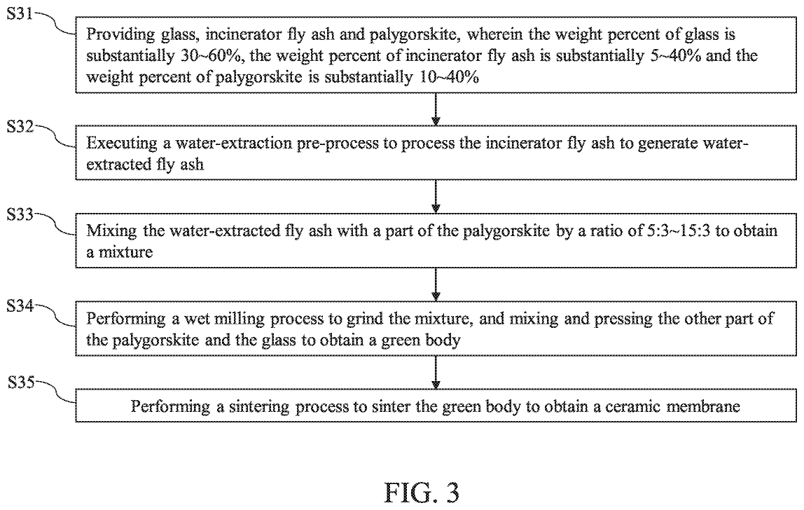

Please refer to FIG. 3, which is a flow chart of the method for manufacturing ceramic membrane by recycling incinerator fly ash in accordance with the third embodiment of the present invention. The manufacturing process of this embodiment may include the following steps:

Step S31: providing glass, incinerator fly ash and palygorskite, wherein the weight percent of glass is substantially 30˜60%, the weight percent of incinerator fly ash is substantially 5˜40% and the weight percent of palygorskite is substantially 10˜40%.

Step S32: executing a water-extraction pre-process to process the incinerator fly ash to generate water-extracted fly ash.

Step S33: mixing the water-extracted fly ash with a part of the palygorskite by a ratio of 5:3˜15:3 to obtain a mixture.

Step S34: performing a wet milling process to grind the mixture, and mixing and pressing the other part of the palygorskite and the glass to obtain a green body.

Step S35: performing a sintering process to sinter the green body to obtain a ceramic membrane.

This embodiment further tests the ceramic membrane manufactured by the above materials and proportions in four performance standards, including heavy metal stabilization, bending strength, soundness and filtering ability. The ceramic membrane is GFKP-6202. In the test, the temperature rise rate is 7° C./min, the sintering temperature is 900° C. and the holding time is 5 minutes. The test result shows that the TCLP (Toxicity characteristic leaching procedure) leaching concentrations of the heavy metals (Pb, Cu, Cd and total Cr) of the ceramic membrane can be lower than 1/10 of the reuse management standards for incinerator bottom ash of Taiwan's Environmental Protection Administration. Thus, the ceramic membrane conforms to reuse management standards for incinerator bottom ash. The test result shows that the permeate flux of the ceramic membrane is about 19˜100 m³/m²/d when the film pressure is about 0.17˜0.79 kgf/cm². The test result shows the filtering ability of mixed liquid suspended solids (MLSS) of the ceramic membrane is close to 100% (the original concentration of the suspended solids is about 2000 mg/L). The test result shows that the ceramic membrane conforms to the requirement that the weight loss is less than 18% after the ceramic membranes are tested according to CNS A1167 “Method of Test for Soundness of Aggregate by Use of Sodium Sulfate or magnesium Sulfate”.

To sum up, in one embodiment of the present invention, the ceramic membrane manufacturing method consumes a large amount of incinerator fly ash to manufacture ceramic membranes, so can effectively recycle and reuse the incinerator fly ash. Thus, the amount of the incinerator fly ash needed to be solidified by cement-based solidification technique can be reduced and the service life of landfills can be increased.

In one embodiment of the present invention, the ceramic membrane manufacturing method consumes a large amount of incinerator fly ash and glass to manufacture ceramic membranes, so can effectively recycle and reuse both of incinerator fly ash and glass. Therefore, the method can further satisfy the environmental protection requirements.

Besides, in one embodiment of the present invention, the ceramic membrane manufacturing method consumes a large amount of wastes, including incinerator fly ash and glass to manufacture ceramic membranes, so can significantly reduce the cost of the ceramic membranes. Thus, the product competitiveness of the ceramic membranes can be further increased to realize high commercial value.

Further, in one embodiment of the present invention, the ceramic membranes manufacturing by using incinerator fly ash can be applied to produce membrane bioreactors (MBR) for wastewater treatment and water recycling. Hence, incinerator fly ash can be effectively recycled and reused if the above products are acceptable by most consumers and attain high market share.

Moreover, in one embodiment of the present invention, the ceramic membrane manufacturing method integrates a multi-stage mixing process with a wet milling process to process incinerator fly ash, and execute a sintering process to sinter the grinded fly ash stabilized by the wet milling process to obtain a ceramic membrane. In this way, the method can effectively suppress the leaching of the heavy metals from the incinerator fly ash of the ceramic membrane, so the ceramic membrane can effectively stabilize heavy metals in fly ash. Therefore, the ceramic membrane can correspond with actual needs.

Furthermore, in one embodiment of the present invention, the ceramic membranes manufactured by the method according to the present invention can achieve great performance in bending strength, soundness and filtering ability. Therefore, the ceramic membranes can further satisfy the actual needs.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A ceramic membrane, comprising:
a glass, wherein a weight percent of the glass is substantially 30˜60%;
an incinerator fly ash, wherein a weight percent of the incinerator fly ash is substantially 5˜30%;
a kaolin, wherein a weight percent of the kaolin is substantially 5˜50%; and
a palygorskite, wherein a weight percent of the palygorskite is substantially 5˜30%.

2. The ceramic membrane of claim 1, wherein the weight percent of the glass is substantially 40˜60%, the weight percent of the incinerator fly ash is substantially 10˜30%, the weight percent of the kaolin is substantially 10˜40% and the weight percent of the palygorskite is substantially 10˜30%.

3. The ceramic membrane of claim 1, wherein the weight percent of the glass is substantially 50˜60%, the weight percent of the incinerator fly ash is substantially 10˜20%, the weight percent of the kaolin is substantially 10˜20% and the weight percent of the palygorskite is substantially 10˜20%.

4. The ceramic membrane of claim 1, wherein the incinerator fly ash is processed by a water extraction pre-process to generate a water-extracted fly ash.

5. The ceramic membrane of claim 4, wherein the water-extracted fly ash is mixed with a part of the palygorskite by a ratio of 5:3˜15:3 to generate a mixture and a wet milling process is implemented to grind the mixture, wherein the mixture, the other part of the palygorskite, the glass and the kaolin are mixed and pressed after the grinding process to obtain a green body, and a ceramic membrane is obtained after the green body is sintered by a sintering process.

6. The ceramic membrane of claim 1, wherein the incinerator fly ash includes a reaction fly ash and a boiler fly ash.

7. A ceramic membrane manufacturing method by recycling incinerator fly ash, comprising:
providing a glass, an incinerator fly ash, a kaolin and a palygorskite, wherein a weight percent of the glass is substantially 30˜60%, a weight percent of the incinerator fly ash is substantially 5˜40%, a weight percent of the kaolin is substantially 5˜50% and a weight percent of the palygorskite is substantially 5˜30%;
executing a water-extraction pre-process to process the incinerator fly ash to generate a water-extracted fly ash;
mixing and pressing the glass, the water-extracted fly ash, the kaolin and the palygorskite to obtain a green body; and
performing a sintering process to sinter the green body to obtain a ceramic membrane.

8. The method of claim 7, wherein the weight percent of the glass is substantially 40˜60%, the weight percent of the incinerator fly ash is substantially 10˜40%, the weight percent of the kaolin is substantially 10˜40% and the weight percent of the palygorskite is substantially 10˜30%.

9. The method of claim 7, wherein the weight percent of the glass is substantially 50˜60%, the weight percent of the incinerator fly ash is substantially 20˜33%, the weight percent of the kaolin is substantially 10˜20% and the weight percent of the palygorskite is substantially 10˜20%.

10. The method of claim 7, further comprising:
mixing the water-extracted fly ash with a part of the palygorskite by a ratio of 5:3˜15:3 to generate a mixture; and
performing a wet milling process to grind the mixture, and mixing and pressing the other part of the palygorskite, the glass and the kaolin to obtain the green body.

11. The method of claim 7, wherein the incinerator fly ash includes a reaction fly ash and a boiler fly ash.

12. A ceramic membrane manufacturing method by recycling incinerator fly ash, comprising:
providing a glass, an incinerator fly ash and a kaolin, wherein a weight percent of the glass is substantially 30˜60%, a weight percent of the incinerator fly ash is substantially 5˜40% and a weight percent of the kaolin is substantially 5˜50%;
executing a water-extraction pre-process to process the incinerator fly ash to generate a water-extracted fly ash;
mixing and pressing the glass, the water-extracted fly ash and the kaolin to obtain a green body; and
performing a sintering process to sinter the green body to obtain a ceramic membrane.

13. The method of claim 12, wherein the weight percent of the glass is substantially 40˜60%, the weight percent of the incinerator fly ash is substantially 10˜40% and the weight percent of the kaolin is substantially 20˜50%.

14. The method of claim 12, wherein the weight percent of the glass is substantially 30˜40%, the weight percent of the incinerator fly ash is substantially 20˜33% and the weight percent of the kaolin is substantially 40˜50%.

15. The method of claim 12, further comprising:
performing a wet milling process to grind the water-extracted fly ash.

16. The method of claim 12, wherein the incinerator fly ash includes a reaction fly ash and a boiler fly ash.

17. A ceramic membrane manufacturing method by recycling incinerator fly ash, comprising:
providing a glass, an incinerator fly ash and a palygorskite, wherein a weight percent of the glass is substantially 30˜60%, a weight percent of the incinerator fly ash is substantially 5˜40% and a weight percent of the palygorskite is substantially 10˜40%;
executing a water-extraction pre-process to process the incinerator fly ash to generate a water-extracted fly ash;
mixing and pressing the glass, the water-extracted fly ash and the palygorskite to obtain a green body; and
performing a sintering process to sinter the green body to obtain a ceramic membrane.

18. The method of claim 17, wherein the weight percent of the glass is substantially 40˜60%, the weight percent of the incinerator fly ash is substantially 10˜40% and the weight percent of the palygorskite is substantially 10˜30%.

19. The method of claim 17, wherein the weight percent of the glass is substantially 50˜60%, the weight percent of the incinerator fly ash is substantially 20˜33% and the weight percent of the palygorskite is substantially 20˜30%.

20. The method of claim 7, further comprising:
mixing the water-extracted fly ash with a part of the palygorskite by a ratio of 5:3˜15:3 to generate a mixture; and
performing a wet milling process to grind the mixture, and mixing and pressing the other part of the palygorskite and the glass to obtain the green body.

21. The method of claim 17, wherein the incinerator fly ash includes a reaction fly ash and a boiler fly ash.
